(19) United States
(12) Patent Application Publication
(10) Pub. No.: US 2015/0100313 A1
(43) Pub. Date: Apr. 9, 2015

(54) PERSONIFICATION OF COMPUTING DEVICES FOR REMOTE ACCESS

(71) Applicant: Verizon Patent and Licensing, Inc., Arlington, VA (US)

(72) Inventor: Nityanand Sharma, Tampa, FL (US)

(73) Assignee: VERIZON PATENT AND LICENSING, INC., Arlington, VA (US)

(21) Appl. No.: 14/050,083

(22) Filed: Oct. 9, 2013

(51) Int. Cl. G10L 17/22; G10L 15/26; G10L 15/18; G06F 3/16

(52) U.S. Cl. CPC G10L 17/22; G06F 3/167; G10L 15/26; G10L 15/18
USPC 704/235; 704/275

(57) ABSTRACT

Techniques described herein relate to remote access of computing devices. In one implementation, a method may include receiving a voice command from a first computing device associated with a user and parsing the voice command. The parsing may include determining a label, assigned by the user, to identify a second computing device associated with the user, and an action associated with the second computing device. The method may further include transmitting an indication of the action to the second computing device; receiving results, from the second computing device, relating to execution of the action by the second computing device; and transmitting the results to the first computing device.

### BACKGROUND

Computing devices, such as personal computers, laptops, and tablet computers, may include functionality that may be useful to a user of the computing device even when the computing device is not in proximity to the user. For example, a field technician working in the field may desire to view a file that is stored at a desktop computer located in the technician's office.

### BRIEF DESCRIPTION OF THE DRAWINGS

FIG. 1 is a diagram conceptually illustrating an example of an overview of concepts described herein;

FIG. 2 is a diagram of an example environment in which systems and/or methods described herein may be implemented;

FIG. 3 is a diagram illustrating an example data structure, such as a data structure that may be maintained by a personification server;

FIG. 4 is a diagram illustrating an example of functional components of the personification server;

FIG. 5 is a diagram illustrating an example data structure that may correspond to a data structure that includes a set of commands that are supported by the personification server;

FIG. 6 is a diagram illustrating an example of functional components of the client personification component shown in FIG. 2;

FIG. 7 is a flow chart illustrating an example process relating to the initial registration of a computing device for remote access to the computing device;

FIG. 8 is a flow chart illustrating an example process relating to the providing of remote access to the computing device;

FIG. 9 is a diagram illustrating an example of communications that may be implemented when providing remote access to a computing device based on the process shown in FIG. 8; and

FIG. 10 is a diagram of example components of a device.

### DETAILED DESCRIPTION OF PREFERRED EMBODIMENTS

The following detailed description refers to the accompanying drawings. The same reference numbers in different drawings may identify the same or similar elements.

Techniques described herein enable computing devices, which may be remotely located relative to a user, to be controlled through voice commands. The computing devices may be associated with a user defined name (called a “personification label” herein) that can be used to memorably identify the computing device for the user. The user may use the personification label to remotely issue voice commands, using natural language queries, to the computing device. For example, a field technician that wishes to access a file on a desktop computer may assign the personification label “Big Red” to the desktop computer. To access the desktop computer, the technician may dial a number (or use an application, such as one installed on smart phone) and speak the command “Big Red, send me the files in the folder ‘specifications’.”

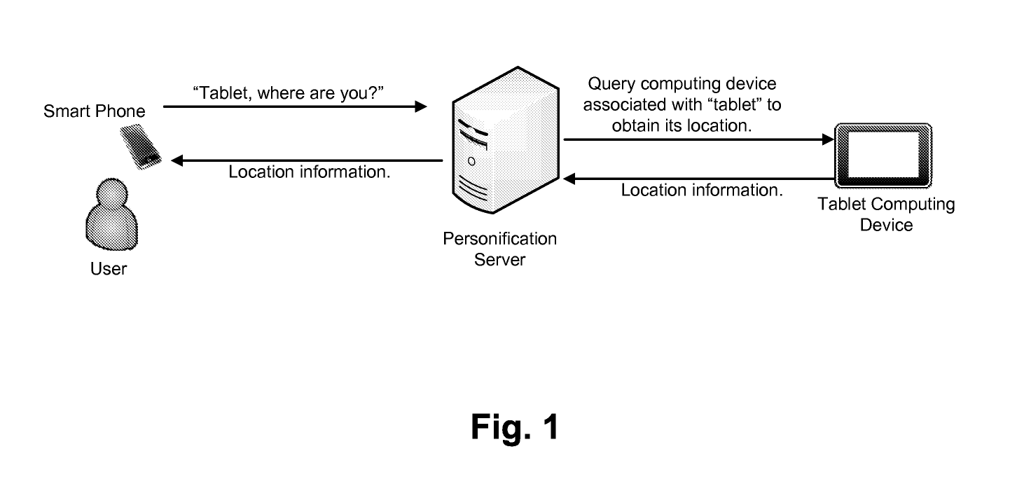

FIG. 1 is a diagram conceptually illustrating an example of an overview of concepts described herein. A user, associated with a mobile device, such as a smart phone, may wish to obtain information stored on or relating to another device associated with the user. For example, the user may possess a tablet computing device. In this example, assume that the user has misplaced the tablet computing device and would like to determine its location. The user may issue a voice command intended for the tablet computing device. The voice command may be issued to one or more server devices, called a personification server herein, such as by placing a telephone call to a designated number or by using an application installed at the mobile device. In some implementations, the voice command may be a natural language query that may correspond to natural, human language. For example, as illustrated, the user may say “Tablet, where are you?” The word “tablet,” in this query, may correspond to the personification label that was previously assigned by the user to the tablet computing device.

In response to the voice command, the personification server may determine that the command corresponds to the tablet computing device of the user and that the user would like to determine the location of the tablet computing device. The personification server may query the tablet computing device to obtain information relating to its location (“location information”). The location information may then be transmitted to the user (e.g., to the smart phone of the user or as spoken information provided over a telephone call). The location information may take the form of, for example, a particular set of latitude and longitude coordinates, an indication of a particular local wireless network to which the tablet computing device is currently connected, a photo taken with a camera of the tablet computing device, or other information that may help the user locate the tablet computing device. As another example, the personification server may cause the tablet computing device to make a noise, which may help the user locate the tablet computing device.

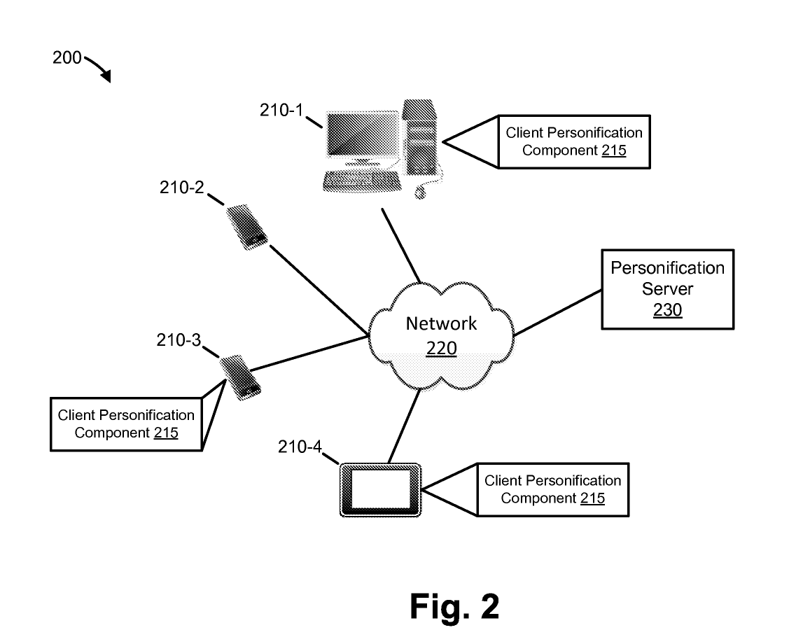

FIG. 2 is a diagram of an example environment 200, in which systems and/or methods described herein may be implemented. As illustrated, environment 200 may include a number of computing devices 210-1 through 210-4 (which may be referred to collectively as computing devices 210 or individually as computing device 210), network 220, and personification server 230. Although four computing devices are illustrated in FIG. 2, in practice, environment 200 may include additional or fewer computing devices 210.

Each of computing devices 210 may include computing devices that are capable of connecting to network 220. In one implementation, computing devices 210 may each include a smart phone, a personal digital assistant (“PDA”) (e.g., that can include a radiotelephone, a pager, Internet/intranet access, etc.); a laptop computer; personal computer; a tablet computer; or another type of computation and communication device. Computing devices 210 may connect to network 220 via wireless and/or wired connections. For example, computing devices 210 may include smart phones (e.g., computing devices 210-2 and 210-3) that connect to network 220 via a wireless cellular connection. As another example, computing device 210-1 may include a desktop computer that connects to network 220 via a wired connection and computing device 210-4 may include a tablet computer that wirelessly connects to network 220 via a local WiFi network.

In some implementations, one or more of computing devices 210 may include an application installed at the computing devices, illustrated in FIG. 2 as client personification component 215. Client personification component 215 may communicate with personification server 230 to provide presence information relating to an online state of computing device 210 and to execute commands on behalf of a remotely located user.

Network 220 may include one or more networks that act to operatively couple user computing devices 210 to personification server 230. Network 220 may include, for example, one or more networks of any type, such as a local area network (LAN), a wide area network (WAN), a metropolitan area network (MAN), a cellular wireless network (e.g., a wireless network based on the Long Term Evolution (LTE) standard), and/or another type of network. In some implementations, network 220 may include packet-based Internet Protocol (IP) networks.

Personification server 230 may include one or more computing devices, which may be co-located or geographically distributed. Although referred to as a “server,” personification server 230 may correspond to a traditional server, a cloud-based service, a cluster of blade or rack-mounted servers, or another implementation that provides services and/or data storage. Personification server 230 may be designed to receive data from computing devices 210 and provide data to computing devices 210. For example, voice commands for a particular computing device 210 may be transmitted to personification server 230, which may identify the particular computing device, corresponding to the command, and the intended action for the particular computing device (e.g., determine the location of the particular computing device, receive a file from the particular computing device, etc.), based on using voice recognition techniques. Personification server 230 may then communicate with the particular computing device to execute/implement the command and may return information relating to a result of the execution/implementation of the command back to the user that provided the command. Personification server 230 will be described in more detail below.

Although FIG. 2 illustrates example components of an environment 200, in other implementations, environment 200 may contain fewer components, different components, differently arranged components, or additional components than those depicted. Alternatively, or additionally, one or more of the depicted components may perform one or more other tasks described as being performed by one or more other ones of the depicted components.

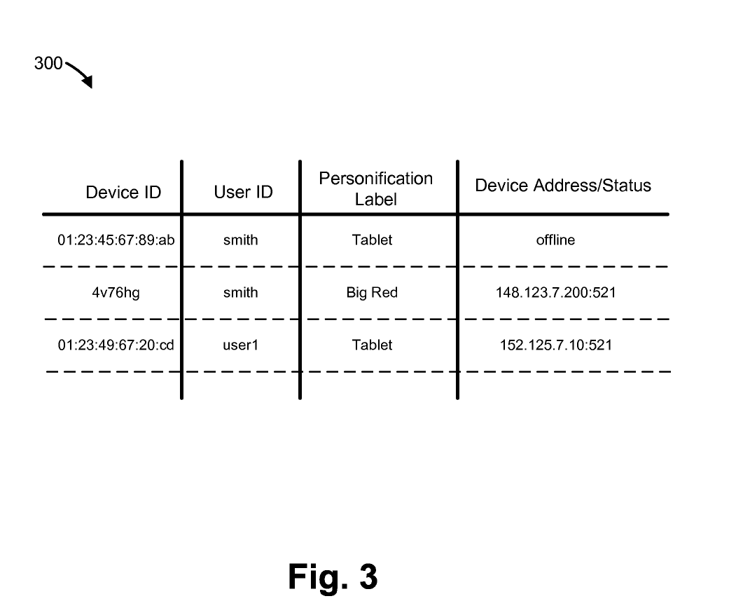

FIG. 3 is a diagram illustrating an example data structure 300, which may be maintained by personification server 230. Data structure 300 may generally be used to store information relating to computing devices 210 and to users of these computing devices.

Data structure 300 may include a number of fields, labeled as: device identification (ID), user ID, personification label, and device address/status. In one implementation, users may initially register computing devices 210 with personification server 230. Each record in data structure 300 may correspond to a registered computing device 210. The fields shown for data structure 300 are examples. In alternative possible implementations, different, fewer, or additional fields may be implemented.

The device ID field may store information that uniquely identifies a particular computing device 210. For example, the device ID field may include a media access control (MAC) address associated with a particular computing device 210, another value associated with the hardware of computing device 210, and/or a value assigned by client personification component 215 (e.g., a randomly generated device identifier). In the example of FIG. 3, the device ID field for the first record in data structure 300 may correspond to a MAC address (e.g., 01:23:45:67:89:ab) and the second and third example records may correspond to other values that identify particular computing devices 210.

The user identification field may store information that uniquely identifies a particular user (or organization or group) associated with one or more computing devices 210. For example, a user that wishes to use services of personification server 230 may initially register with the personification server 230. As part of the registration process, the user may be assigned or may create a user name that may be stored in the user identification field.

The personification label field may store text that the user assigns to the corresponding computing device 210. The personification label, for a computing device, may be a user selectable value, such as a value that the user finds relatively easy to remember. In one implementation, personification labels for a particular user may be required to be unique, but personification labels between different users may be identical (e.g., as shown, two different users may call one of their devices “Tablet”).

Device address/status field may store information indicating the current network address of the corresponding computing device 210. A device that is not accessible (e.g., a device that is offline), may not include an entry in the device address/status field or may include an entry that indicates the computing device is offline (e.g., a null value or an “offline” textual identifier). In one implementation, for computing devices that are online, the value in device address/status field may correspond to the Internet Protocol (IP) address and port number by which the computing device is reachable by personification server 230.

As illustrated in FIG. 3, a single user (e.g., the user “smith”) may be associated with multiple records in data structure 300, which may indicate that the user has registered multiple computing devices 210. In this example, the user “smith” has assigned a personification label of “tablet” (e.g., the user's tablet computing device) to a first computing device associated with the user and has assigned a personification label of “Big Red” (e.g., a user desktop computer of the user that has a red case). In this example, the tablet computer is currently offline and the desktop computer is online and is accessible via the IP address value and port value of 148.123.7.200 and 521, respectively.

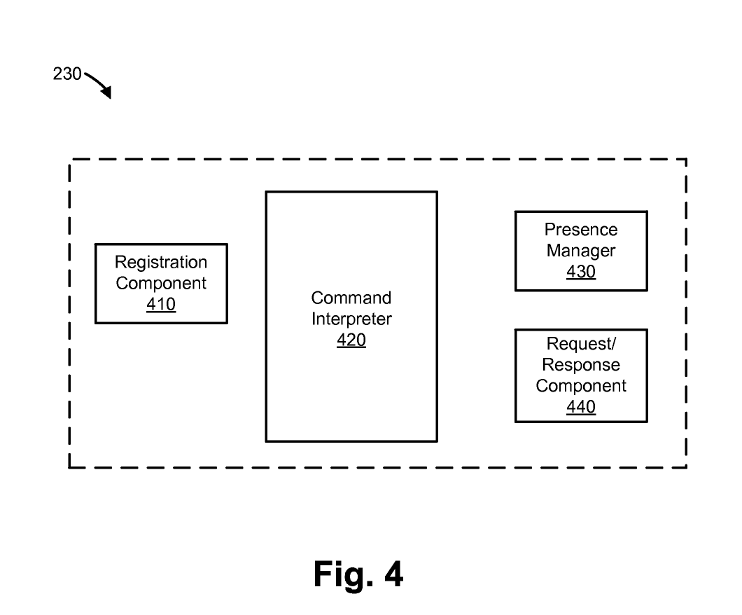

FIG. 4 is a diagram illustrating an example of functional components of personification server 230. Each functional component illustrated in FIG. 4 may correspond to, for example, functionality implemented by one or more computing devices corresponding to personification server 230. As illustrated, the functional components may include registration component 410, command interpreter 420, presence manager 430, and request/response component 440.

Registration component 410 may implement logic relating to the registration of computing devices 210 by users. For example, when a user wishes to register a computing device as a computing device that is be eligible to remotely implement commands, the user may install client personification component 215 on the computing device. As part of the installation of client personification component 215, the user may enter a personification label for the computing device. Client personification component 215 may transmit the personification label to registration component 410, which may correspondingly update data structure 300. In some implementations, client personification component 215 may also transmit a device ID value to registration component 410, which may correspondingly update data structure 300.

Command interpreter 420 may include logic to interpret commands entered by users. Command interpreter 420 may store a set of predefined acceptable or usable commands. In one implementation, command interpreter 420 may implement speech recognition software to convert voice commands to a textual representation of the voice commands. Command interpreter 420 may convert the textual representation of the voice commands to a command in the set of predefined acceptable or useable commands.

As one example of the operation of command interpreter 420 in processing a command, assume that command interpreter 420 receives an audible command (i.e., voice command), such as from a user that inputs a voice command via an application installed on a smart phone. The command may be “Tablet, run the program Process One” (i.e., a command to remotely execute a particular program). Command interpreter 420 may convert the voice command into a textual representation (or other representation) based on the application of speech recognition techniques to the voice command. The textual representation of the voice command may then be compared to textual representations of the acceptable/useable commands that are stored by command interpreter 420. As part of this comparison, the personification labels associated with the user that submits the audible command may be matched to the textual representation (or previously matched in the audible domain) to determine the computing device 210 at which the user intends the command to be performed. Command interpreter 420 may output an indication of the intended command (“run the program”), the computing device that is to execute the command (“Tablet”), and any objects or parameters associated with the command (“Process One”).

In some implementations, command interpreter 420, instead of operating on an audible command, may operate directly based on a text command. For example, a user may directly enter the command as a text command (e.g., via a virtual keyboard of a smart phone). In this situation, command interpreter 420 may not need to perform speech recognition.

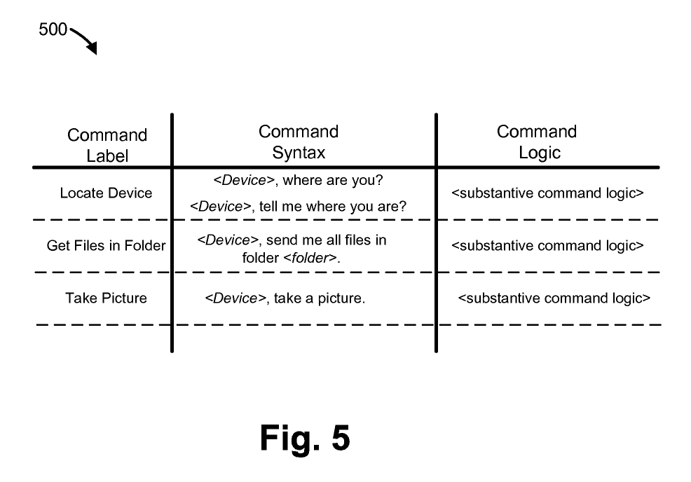

FIG. 5 is a diagram illustrating an example data structure 500 that may include commands supported by personification server 230. As illustrated, data structure 500 may include a number of fields, labeled as: command label, command syntax, and command logic. Each record in data structure 500 may correspond to a command that may be supported by personification server 230. The fields shown for data structure 500 are examples. In alternative possible implementations, different, fewer, or additional fields may be implemented.

In data structure 500, the command label field may include a label or title that identifies the particular command corresponding to the record in data structure 500. Three example commands are illustrated in FIG. 5: a command to locate computing device 210 (“Locate Device”), a command to get files in a particular folder of computing device 210 (“Get Files in Folder”), and a command to take a picture (“Take Picture”).

The command syntax field may include, for each supported command, one or more templates that may correspond to the command. Each template may represent a natural language expression of the command. In the illustrated templates, terms in italic and setoff using the symbols “<” and “>” may indicate parameters associated with the command. For example, the command “locate device” may be invoked by the user saying “<Device>, where are you” or “<Device>, tell me where you are?”. In either expression, the term Device may correspond to a parameter for the command (e.g., a personification label). As is further shown in FIG. 5, the command “Get Files in Folder” may be invoked by the user saying “<Device>, send me all files in folder <folder>,” where Device (personification label) and folder (identification of the folder of interest) may be parameters. Additionally, the command “Take Picture” may be invoked by the user saying “<Device>, take a picture,” where Device (personification label) may be a parameter for this command.

The command logic field may include or reference logic to implement the corresponding command. In one implementation, each entry in the command logic field may include a script or other program that may be transmitted, for execution, to a computing device 210. In another possible implementation, the substantive logic (e.g., script or other code) to implement each command may be stored locally by client personification components 215. In some such implementations, data structure 500 may include references to the substantive logic.

Referring back to FIG. 4, presence manager 430, of personification server 230, may include logic to keep track of the offline/online state (i.e., the network presence) of computing devices 210. For example, in one implementation, when computing device 210 is turned on and connected to network 220, client personification component 215 may periodically or occasionally communicate with presence manager 430 to inform presence manager 430 that the computing device 210 is online. Presence manager 430 may update data structure 300 to indicate the online/offline status of the computing device and/or to indicate the address of the computing device (e.g., the IP address and port number associated with the instance of client personification component 215 that is being executed by the computing device).

Request/response component 440 may include logic to handle requests and responses associated with computing devices 210 that are the object of a user command. For example, request/response component 440 may communicate with client personification component 215, of a computing device 210, to provide a command to client personification component 215. Request/response component 440 may receive the result of the command from client personification component 215, and may forward the result to the computing device from which the initial command was received.

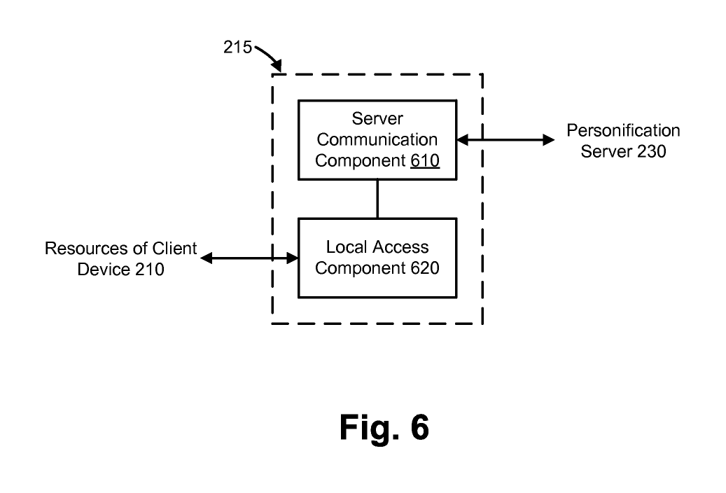

FIG. 6 is a diagram illustrating an example of functional components of client personification component 215. As illustrated, the functional components may include server communication component 610 and local access component 620.

Server communication component 610 may include logic to communicate with personification server 230 (e.g., with request/response component 440). Server communication component 610 may, for example, initiate a connection with personification server 230 when the computing device that includes server communication component 220 is initially turned on. Server communication component 610 may further provide periodic or occasional presence updates to personification server 230. Server communication component 610 may additionally receive commands (e.g., Locate Device, Get Files in Folder, Take Picture, etc.) from personification server 230 and transmit data back to server communication component 610 in response to execution of the commands.

Local access component 620 may include logic to implement the commands received from personification server 230. For example, as previously mentioned, each command may be associated with substantive command logic (e.g., computer executable instructions) that may be stored locally by client personification component 215 or may be received, as part of a command, from personification server 230. Parameters corresponding to a particular command (e.g., identification of a particular folder or file that is the object of the command) may also be received as part of the command. Local access component 620 may implement the command by accessing resources associated with the corresponding computing device 210. For example, local access component 620 may perform search related operations of a hard drive or other storage device corresponding to the computing device (e.g., find a particular folder or file), read data from the hard drive or other storage device, access or use hardware associated with the computing device (e.g., a camera), run programs implemented by the computing device, or perform other operations relating to the resources of computing device 210. Local access component 620 may provide the result of the command to server communication component 610, which may forward the results to personification server 230.

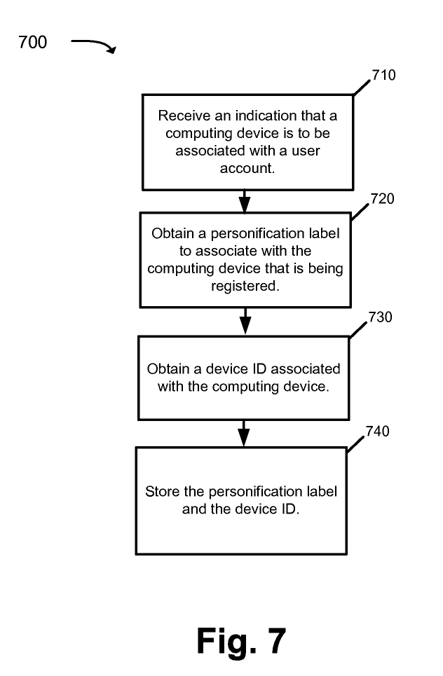

FIG. 7 is a flow chart illustrating an example process 700 relating to the initial registration of a computing device for remote access to the computing device. Process 700 may be performed, for example, by personification server 230.

Process 700 may include receiving an indication that a computing device is to be associated with a user account (block 710). As previously discussed, a user may obtain a user ID as part of initial registration of the user account. The user may register one or more computing devices 210 that the user wishes to access via the techniques described herein. As an example, registering a computing device 210 may include installing software such as client personification component 215 at the computing device. As part of the installation of client personification component 215, client personification component 215 may contact personification server 230 to indicate that a new computing device 210 is being registered.

Process 700 may further include obtaining a personification label that is to be associated with the computing device that is being registered (block 720). In one implementation, the personification label may be a word or phrase that is selected by the user. For example, during installation of client personification component 215, client personification component 215 may request that the user enter a personification label. Client personification component 215 may transmit the personification label to personification server 230.

Process 700 may further include obtaining the device identifier associated with the computing device (block 730). For example, in one implementation, the device identifier the may be obtained by client personification component 215 (e.g., by reading the MAC address, or another hardware identification value, of the computing device at which client personification component 215 is installed). Client personification component 215 may transmit the device identifier to personification server 230.

Process 700 may further include storing the obtained personification label and device identifier (block 740). For example, personification server 230 may create a new record in data structure 300 to store the obtained device identifier and personification label.

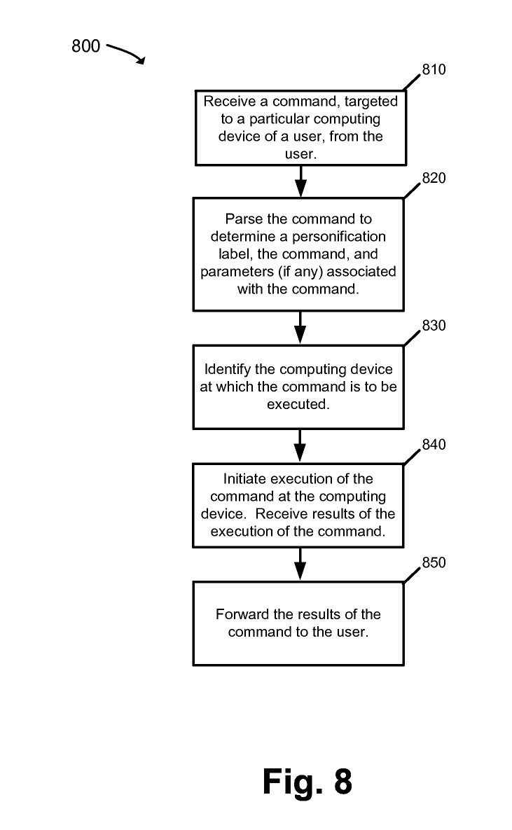

FIG. 8 is a flow chart illustrating an example process 800 relating to the providing of remote access to computing devices. Process 800 may be performed, for example, by personification server 230.

Process 800 may include receiving a command, targeted to a particular computing device of a user, from the user (block 810). As previously mentioned, the command may be a command relating to the access of a previously registered computing device of the user. The command may include a command such as one of the commands illustrated in data structure 500 (FIG. 5) and the particular computing device may be identified using a personification label that was previously associated with the particular computing device (e.g., as performed in process 700). In one implementation, the command may be voice (audible) command, such as a voice command provided by a user that dials a telephone number associated with personification server 230 or a voice command provided by the user using an application installed at a client computing device (e.g., a voice command provided using client personification component 215, which may transmit the voice command as, for example, an audio file (e.g., an mp3 file)). In another possible implementation, the command may be a text command (e.g., a command typed by the user).

Process 800 may further include parsing the command to determine a personification label, an identification of the substantive command (e.g., “Where am I”), and additional parameters (if any) that are associated with the command (block 820). In situations in which the command is a voice command, parsing the command may include using speech recognition technologies to convert the voice command to a non-audible form (e.g., a textual form). The non-audible form of the command may then be compared to a template of command syntaxes (e.g., in the command syntax field of data structure 500) to obtain an indication of the closest matching command (i.e., an indication of the action to be performed), the personification label, and the additional command parameters (if any). The command syntaxes may be structured to embody natural language commands. In situations in which the command is not a voice command (e.g., it is a text command), parsing the command may including comparing the command to the template command syntaxes. In one implementation, because the user identifier may be known for any submitted command, the set of know personification labels corresponding to the user identifier may be used to simplify the determination of the personification label from the command. Parsing the command, as performed in block 820, may be performed by command interpreter 420.

Process 800 may further include identifying the computing device at which the command is to be executed (block 830). As previously mentioned, each registered computing device may be associated with a personification label for the computing device. The identification of the computing device may thus correspond to a look up of the computing device based on the personification label.

Process 800 may further include initiation of execution of the command at the identified computing device (block 840). Based on the execution of the command at the identified computing device, the result of the command may be received (block 840). For example, request/response component 440 may transmit the command to client personification component 215 of the identified computing device. Client personification component 215 may execute the command to obtain one or more results (e.g., a location of the computing device, a file from the computing device, etc.), and may transmit the results back to request/response component 440 of personification server 230.

In some implementations, a particular command may not correspond to any results being transmitted back to personification server 230. For example, the results may be based on a voice command such as “<Device>, play the song <song>” or “<Device>, set the thermostat to <temperature>.” These commands may result in an action being performed by the identified computing device without necessarily generating result information. In this situation, the results returned to personification server 230 may include an indication of whether the action was successfully performed.

Process 800 may further include forwarding the result of the command to the user (block 850). For example, personification component 230 may forward the result associated with the command (e.g., a file, a message including the substantive information of the result (e.g., the location of the identified computing device), a message indicating whether the command was successfully performed, etc.) to a computing device 210 that is being used by the user (e.g., a smart phone). As another example, in the situation in which the command submitted to personification server 230 is a voice command submitted via a telephone call, forwarding the result of the command to the user may be performed audibly, such as via a voice message indicating whether the command was successfully completed.

In one alternative possible implementation, instead of the results of the command being received by personification server 230, the results of the command may be directly transmitted, by the identified computing device, to the computing device being used by the user.

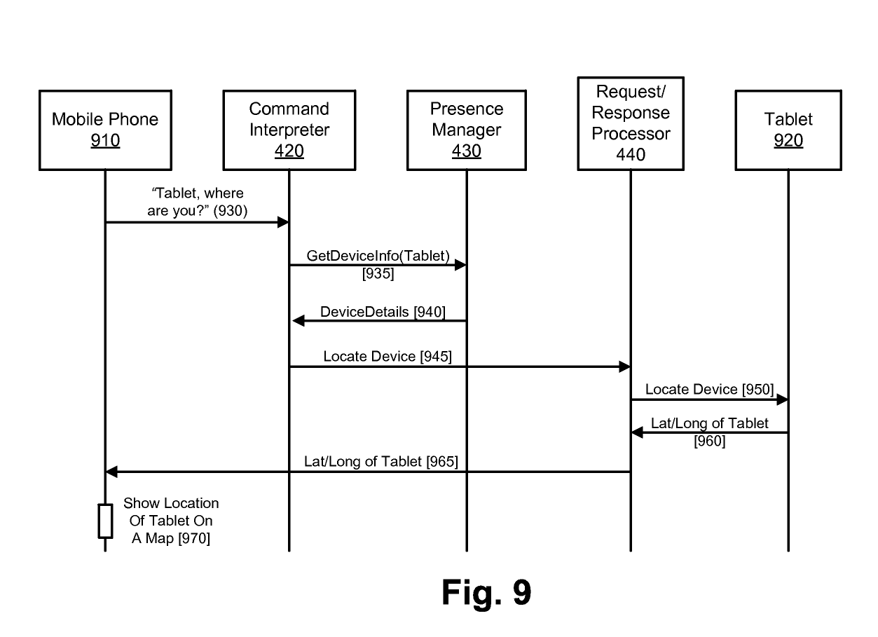

FIG. 9 is a diagram illustrating one example of communications that may be implemented when providing remote access to computing devices based on process 800. The communications of FIG. 9 will be described in the context of the example components of personification server 230 that are illustrated in FIG. 4. Also, in the example of FIG. 9, assume that the user issuing the command issues a “Locate Device” command via a mobile phone 910, where the command is directed to a tablet computing device (tablet 920) that was previously registered by the user and was associated with the personification label “tablet.”

The user may speak the voice command “Tablet, where are you?”, which may be transmitted (e.g., via a telephone call or a data connection) to command interpreter 420 (communication 930). Command interpreter 420 may parse the command to determine that the voice command represents a command to determine the location of the user's computing device associated with the personification label “tablet.” Command interpreter 420 may communicate with presence manager 430 (communication 935, “GetDeviceInfo(Tablet)”) to determine the presence state of the tablet (e.g., whether the tablet is online and/or the network address of the tablet). Presence manager 430 may respond with the current network address of the tablet (communication 940, “DeviceDetails”).

Command interpreter 420 may subsequently issue a command to locate the tablet. For example, the command may be forwarded to request/response processor 440, which may handle the actual communication with tablet 920 (communications 945 and 950, “Locate Device”). In response to receiving the “Locate Device” command, tablet 920 (e.g., client personification component 215 of tablet 920) may determine the location of the tablet, such as the latitude and longitude of the tablet, as determined via a global positioning system (GPS) look up, and return the location information to mobile phone 910 (communications 960 and 965). Mobile phone 910 may provide the information to the user of the mobile phone, such as by showing the location of the tablet overlaid on a map (communication 970).

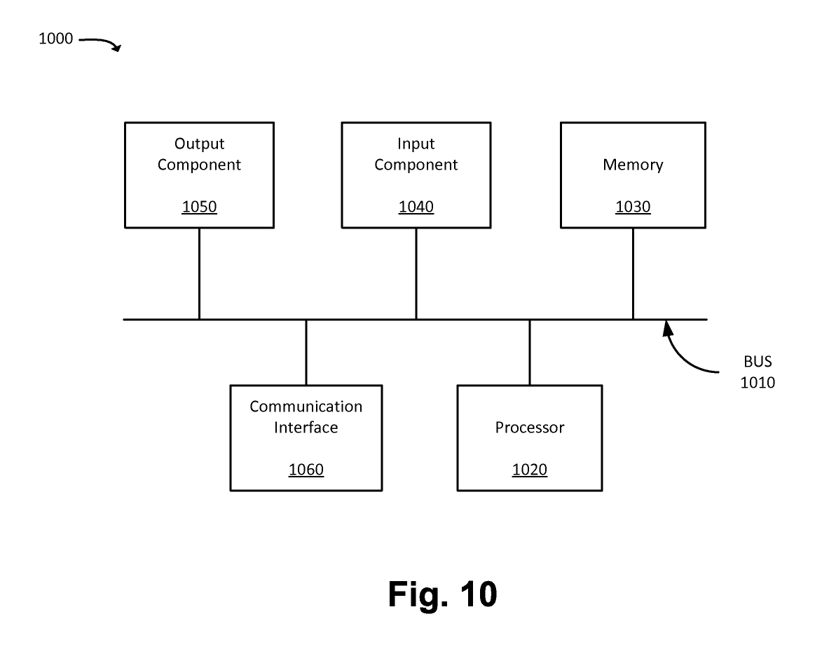

FIG. 10 is a diagram of example components of a device 1000. The devices illustrated in FIGS. 1, 2, 4, and 6 may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000, such as a keyboard, a keypad, a button, a switch, etc. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (“IR”) receiver, a Bluetooth radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations described above. Device 1000 may perform these operations in response to processor 1020 executing software instructions stored in a computer-readable medium, such as memory 1030. A computer-readable medium may be defined as a non-transitory memory device. A memory device may include space within a single physical memory device or spread across multiple physical memory devices. The software instructions may be read into memory 1030 from another computer-readable medium or from another device. The software instructions stored in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while series of blocks have been described with regard to FIGS. 6 and 7, the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as “logic” that performs one or more functions. This logic may include hardware, such as an ASIC or a FPGA, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. A method implemented by one or more devices, the method comprising:
receiving, by the one or more devices, a voice command from a first computing device associated with a user;
parsing, by the one or more devices, the voice command to determine:
a label, assigned by the user, that identifies a second computing device associated with the user, and
an action associated with the second computing device;
transmitting, by the one or more devices, an indication of the action to the second computing device;
receiving results, by the one or more devices and from the second computing device, relating to execution of the action by the second computing device; and
transmitting, by the one or more devices, the results to the first computing device.

2. The method of claim 1, wherein parsing the voice command further includes:
determining, based on speech recognition techniques, a textual representation of the voice command; and
comparing the textual representation of the voice command to a plurality of command syntax templates corresponding to allowable voice commands.

3. The method of claim 2, wherein the plurality of command syntax templates represent commands structured as natural language commands.

4. The method of claim 1, wherein parsing the voice command further includes:
determining parameters associated with the action, wherein transmitting the indication of the action includes transmitting the indication of the action and the determined parameters to the second computing device.

5. The method of claim 1, further comprising:
maintaining information relating to an online presence of a plurality of computing devices, including the second computing device, the information relating to an online presence of the plurality of computing devices including network addresses of the plurality of computing devices,
wherein transmitting the indication of the action to the second computing device is based on the network addresses of the plurality of computing devices.

6. The method of claim 1, wherein the action associated with the second computing device includes:
an action relating to determination of a location of the second computing device,
an action relating to initiation of execution of a program by the second computing device, or
an action relating to retrieving one or more documents from the second computing device.

7. The method of claim 1, further comprising:
registering a third computing device, associated with the user, to remotely perform actions, the registering including receiving a label corresponding to the third computing device, the label corresponding to the third computing device being determined by the user and being unique with respect to other labels determined by the user.

8. The method of claim 1, wherein the voice command is received over a voice telephone call and the results are transmitted, via the voice telephone all, as audible results.

9. A server device comprising:
a memory; and
at least one processor to execute instructions in the memory to:
receive a voice command from a first computing device associated with a user;
parse the voice command to determine:
a label, assigned by the user, that identifies a second computing device associated with the user, and
an action associated with the second computing device;
transmit an indication of the action to the second computing device;
receive results, from the second computing device, relating to execution of the action by the second computing device; and
transmit the results to the first computing device.

10. The server device of claim 9, wherein, when parsing the voice command, the at least one processor is to further execute the instructions in the memory to:
determine, based on speech recognition techniques, a textual representation of the voice command; and
compare the textual representation of the voice command to a plurality of command syntax templates corresponding to allowable voice commands.

11. The server device of claim 10, wherein the plurality of command syntax templates represent commands structured as natural language commands.

12. The server device of claim 9, wherein, when parsing the voice command, the at least one processor is to further execute the instructions in the memory to:
determine parameters associated with the action, wherein transmitting the indication of the action includes transmitting the indication of the action and the determined parameters to the second computing device.

13. The server device of claim 9, wherein the at least one processor is to further execute the instructions in the memory to:
maintain information relating to an online presence of a plurality of computing devices, including the second computing device, the information relating to an online presence of the plurality of computing devices including network addresses of the plurality of computing devices,
wherein transmitting the indication of the action to the second computing device is based on the network addresses of the plurality of computing devices.

14. The server device of claim 9, wherein the action associated with the second computing device includes:
an action relating to determination of a location of the second computing device,
an action relating to initiation of execution of a program by the second computing device, or
an action relating to retrieving one or more documents from the second computing device.

15. The server device of claim 9, wherein the at least one processor is to further execute the instructions in the memory to:
register a third computing device, associated with the user, to remotely perform actions, the registration including receiving a label corresponding to the third computing device, the label corresponding to the third computing device being determined by the user and being unique with respect to other labels determined by the user.

16. The server device of claim 9, wherein the voice command is received over a voice telephone call and the results are transmitted, via the voice telephone all, as audible results.

17. A non-transitory computer-readable medium, comprising:
a plurality of processor-executable instructions stored thereon which, when executed by one or more processors of a server device, cause the one or more processors to:
receive a natural language command from a first computing device associated with a user;
identify a personification label included as part of the natural language command, the personification label having been assigned to a second computing device by the user;
identify an action included as part of the natural language command;
identify, based on the personification label, the second computing device;
determine, based on communications received from the second computing device, a network address associated with the second computing device;
transmit, to the second computing device and based on the determined network address, information identifying the action;
receive results, from the second computing device, relating to execution of the action by the second computing device; and
transmit the results to the first computing device.

18. The non-transitory computer-readable medium of claim 17, wherein the action includes a request to locate the second computing device.

19. The non-transitory computer-readable medium of claim 17, wherein the action includes a request for one or more files associated with the second computing device.

20. The non-transitory computer-readable medium of claim 17, wherein the natural language command is received as a voice command and wherein the plurality of processor-executable instructions are further to cause the one or more processors to:
convert the voice command to a textual representation.
